(19) United States
(12) Patent Application Publication
(10) Pub. No.: US 2022/0076074 A1
(43) Pub. Date: Mar. 10, 2022

(54) MULTI-SOURCE DOMAIN ADAPTATION WITH MUTUAL LEARNING

(71) Applicant: BEIJING DIDI INFINITY TECHNOLOGY AND DEVELOPMENT CO., LTD., Beijing (CN)

(72) Inventors: Zhenpeng LI, Beijing (CN); Yuhong GUO, Beijing (CN); Zhen ZHAO, Beijing (CN)

(73) Assignee: BEIJING DIDI INFINITY TECHNOLOGY AND DEVELOPMENT CO., LTD., Beijing (CN)

(21) Appl. No.: 17/016,297

(22) Filed: Sep. 9, 2020

(51) Int. Cl. G06K 9/62; G06K 9/68; G06K 9/00; G06N 3/08; G06N 3/04

(52) U.S. Cl. CPC G06K 9/6259; G06K 9/685; G06K 2009/6871; G06N 3/08; G06N 3/0454; G06K 9/00791

(57) ABSTRACT

In embodiments of the present disclosure, a method, device and computer-readable medium for multi-source domain adaptation are provided. The method comprises generating a first representation of a target image through a first trained classifier, generating a second representation of the target image through a second trained classifier, and generating a third representation of the target image through a third trained classifier. A mutual learning is conducted among the first, second and third classifiers during the training. The method further comprises determining a classification label of the target image based on the first, second and third representations. The present disclosure proposes a mutual learning network for multi-source domain adaptation, which can improve the accuracy of label generation for images.

### TECHNICAL FIELD

Embodiments of the present disclosure generally relate to the field of computers, and more specifically to a method, device and computer program product for multi-source domain adaptation.

### BACKGROUND

Artificial neural networks have produced great advances for many prediction tasks. Such success depends on the availability of a large amount of labeled training data under a standard supervised learning setting, but the labels are typically expensive and time-consuming to collect. Domain adaptation is a field associated with machine learning and transfer learning, and can reduce the labeling cost by exploiting existing labeled data in a source domain. The domain adaptation aims at transferring knowledge from the source domain to train a prediction model in a target domain.

Unsupervised domain adaptation (UDA) is a widely used domain adaptation setting, where data in the source domain is labeled while data in the target domain is unlabeled. Thus, UDA methods make predictions for the target domain while manual labels or annotations are only available in the source domain. Generally, UDA methods assume the source domain data comes from the same source and have the same distribution, and leverages features from a labeled source domain and train a classifier for an unlabeled target domain.

### SUMMARY

Embodiments of the present disclosure provide a method, device and computer program product for multi-source domain adaptation.

According to one aspect of the present disclosure, there is provided a computer-implemented method. The method comprises generating a first representation of a target image in a target data through a first classifier, generating a second representation of the target image through a second classifier, and generating a third representation of the target image through a third classifier. The first classifier is trained using a first source data and the target data, the second classifier is trained using a second source data and the target data, and the third classifier is trained using at least the first and second source data and the target data. During the training, a mutual learning is conducted among the first, second and third classifiers. That is, the third classifier and the first classifier learn from each other, while the third classifier and the second classifier also learn from each other. The first and second source data comprises labeled images, while the target data comprises unlabeled images. The method further comprises determining a label of the target image based on the first, second and third representations.

According to one aspect of the present disclosure, there is provided an electronic device. The electronic device comprises a processing unit and a memory coupled to the processing unit and storing instructions thereon. The instructions, when executed by the processing unit, perform acts comprising generating a first representation of a target image in a target data through a first classifier, generating a second representation of the target image through a second classifier, and generating a third representation of the target image through a third classifier. The first classifier is trained using a first source data and the target data, the second classifier is trained using a second source data and the target data, and the third classifier is trained using at least the first and second source data and the target data. During the training, a mutual learning is conducted among the first, second and third classifiers. That is, the third classifier and the first classifier learn from each other, while the third classifier and the second classifier also learn from each other. The first and second source data comprise labeled images, while the target data comprises unlabeled images. The acts further comprise determining a label of the target image based on the first, second and third representations.

According to one aspect of the present disclosure, there is provided a computer program product. The computer program product comprises executable instructions. The executable instructions, when executed on a device, cause the device to perform acts comprising generating a first representation of a target image in a target data through a first classifier, generating a second representation of the target image through a second classifier, and generating a third representation of the target image through a third classifier. The first classifier is trained using a first source data and the target data, the second classifier is trained using a second source data and the target data, and the third classifier is trained using at least the first and second source data and the target data. During the training, a mutual learning is conducted among the first, second and third classifiers. That is, the third classifier and the first classifier learn from each other, while the third classifier and the second classifier also learn from each other. The first and second source data comprise labeled images, while the target data comprises unlabeled images. The acts further comprise determining a label of the target image based on the first, second and third representations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will be made more apparent by describing the present disclosure in more detail with reference to drawings. In the drawings, the same or like reference signs represent the same or like elements, wherein:

FIG. 1 illustrates an example environment for multi-source domain adaptation according to embodiments of the present disclosure;

FIG. 2 illustrates a flow chart of a method for multi-source domain adaptation according to embodiments of the present disclosure;

FIG. 3 illustrates an architecture of a mutual learning network for multi-source domain adaptation according to embodiments of the present disclosure;

FIG. 4 illustrates a schematic diagram for sharing weights among all the subnetworks in the mutual learning network according to an embodiment of the present disclosure;

FIG. 5 illustrates a flow chart of a method for iteratively training the mutual learning network for multi-source domain adaptation according to embodiments of the present disclosure; and

FIG. 6 illustrates a schematic diagram for using the trained mutual learning network for determining a label of a target image in the target domain according to embodiments of the present disclosure.

FIG. 7 illustrates a block diagram of an electronic device in which one or more embodiments of the present disclosure may be implemented.

### DETAILED DESCRIPTION

Embodiments of the present disclosure will be described in more detail below with reference to figures. Although the drawings show some embodiments of the present disclosure, it should be appreciated that the present disclosure may be implemented in many forms and the present disclosure should not be understood as being limited to embodiments illustrated herein. On the contrary, these embodiments are provided herein to enable more thorough and complete understanding of the present disclosure. It should be appreciated that drawings and embodiments of the present disclosure are only used for exemplary purposes and not used to limit the protection scope of the present disclosure.

As used herein, the term “comprise” and its variants are to be read as open terms that mean “comprise, but not limited to.” The term “based on” is to be read as “based at least in part on.” The term “an embodiment” is to be read as “at least one embodiment.” The term “another embodiment” is to be read as “at least one other embodiment.” The term “some embodiments” is to be read as “at least some embodiments.” Definitions of other terms will be given in the text below.

Traditional unsupervised domain adaptation (UDA) methods generally assume the setting of a single source domain, where all the labeled source data come from the same distribution. However, in practice, the labeled images may come from multiple source domains with different distributions. In such scenarios, the single source domain adaptation methods may fail due to the existence of domain shifts across different source domains. Some multi-source domain adaptation methods may support multiple source domains, but fail to consider the differences and domain shifts between different source domains.

To this end, a new mutual learning network for multi-source domain adaptation is proposed, which can improve the accuracy of label prediction for images. Consider that multiple source domains have different distributions, embodiments of the present disclosure build one adversarial adaptation subnetwork (referred to as “branch subnetwork”) for each source-target pair and a guidance adversarial adaptation subnetwork (referred to as “guidance subnetwork”) for the combined multi-source-target pair. In addition, multiple branch subnetworks are aligned with the guidance subnetwork to achieve mutual learning, and the branch subnetworks and the guidance subnetwork can learn from each other during the training and make similar predictions in the target domain. Such a mutual learning network is expected to gather domain specific information from each source domain through branch subnetworks and gather complementary common information through the guidance subnetwork, which can improve the information adaptation efficiency between multi-source domains and the target domain.

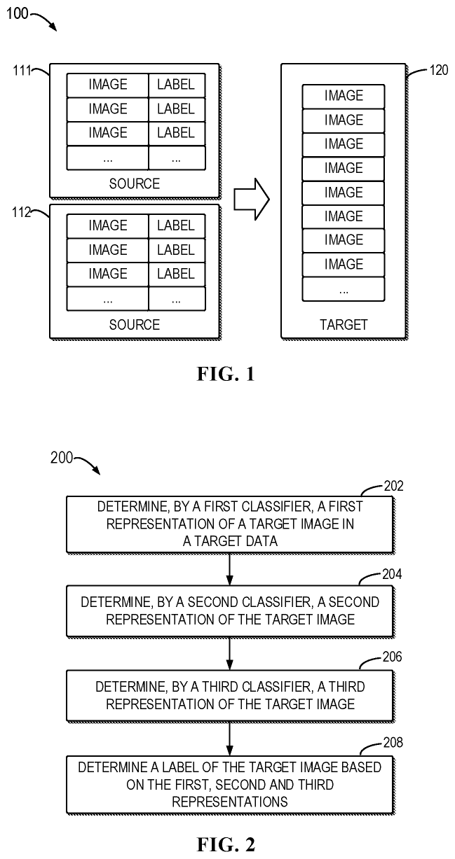

Reference is made below to FIG. 1 through FIG. 7 to illustrate basic principles and several example embodiments of the present disclosure herein.

FIG. 1 illustrates an example environment 100 for multi-source domain adaptation according to embodiments of the present disclosure. In embodiments of the present disclosure, the multiple source domains comprise labeled images, while the target domain comprises unlabeled images. As shown in FIG. 1, a source domain 111 comprises a plurality of images with the corresponding labels, a source domain 112 also comprises a plurality of images with the corresponding labels, while a target domain 120 merely comprises images without the label. According to embodiments of the present disclosure, based on the labels in the source domains 111 and 112, the knowledge in the source domains 111 and 112 can be learned and transferred to the target domain 120. In this way, the trained model may be used to determine the label of each image in the target domain 120.

FIG. 2 illustrates a flow chart of a method 200 for multi-source domain adaptation according to embodiments of the present disclosure. According to the method 200, there are at least two source domains and one target domain, where the source domains comprise labeled images while the target domain comprises unlabeled images.

At 202, a first representation of a target image in a target data is generated by a first classier. For example, the first classier may be trained by using a pair of a first source domain and a target domain as an input. At 204, a second representation of the target image is generated by a second classifier. For example, the second classier may be trained by using a pair of a second source domain and the target domain as an input.

At 206, a third representation of the target image is generated by a third classifier. For example, the third classier is trained by using a pair of the combined first and second source domains and the target domain as an input. In addition, during the training, a mutual learning is conducted among the first, second and third classifiers. That is, the third classifier and the first classifier learn from each other during the training, and the third classifier and the second classifier also learn from each other during the training.

At 208, a label of the target image is determined based on the first, second and third representations. For example, after training the model, multiple classifiers may be obtained from the model, and may be used to predict the label of the unlabeled image in the target domain. The final prediction probability result may be calculated according to the predicted label probability vectors of all the branch subnetworks and the guidance subnetwork.

Since the multiple source domains have different distributions, embodiments of the present disclosure train one branch subnetwork to align each source domain with the target domain, and train a guidance network to align the combined source domains with the target domain. In some embodiments, a guidance network centered prediction alignment may be performed by enforcing divergence regularizations over the prediction probability distributions of target images between the guidance subnetwork and each branch subnetwork so that all subnetworks can learn from each other and make similar predictions in the target domain. Such a mutual learning structure is expected to gather domain specific information from each single source domain through branch subnetworks and gather complementary common information through the guidance subnetwork, and thus embodiments of the present disclosure can improve both the information adaptation efficiency across domains and the robustness of network training.

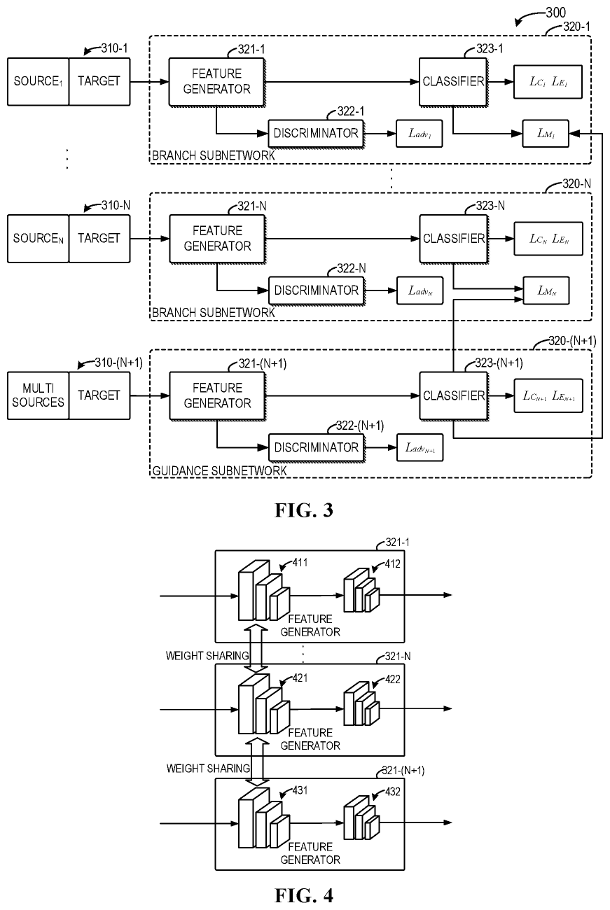

FIG. 3 illustrates an architecture of a mutual learning network 300 for multi-source domain adaptation according to embodiments of the present disclosure. As shown in FIG. 3, assume there are N source domains [symbol] _{S}={ [symbol] _{S}_{ⱼ}}ⱼ₌₁^{N} and one target domain [symbol] _{T}, and the N source domains and the one target domain have different data distributions, wherein N>1. For each source domain, all the images are labeled, thus [symbol] _{S}_{ⱼ}=(X_{S}_{ⱼ}, Y_{S}_{ⱼ})={(Xᵢ^{j}, yᵢ^{j})}ᵢ₌₁ⁿ^{ₛ} ^{^{j}} wherein xᵢ^{j} denotes the i-th image in the j-th source domain, yᵢ^{j} ∈{0, 1}^{K} denotes the corresponding label vector, K denotes a length of the label vector, and nₛ^{j} denotes the number of images in the j-th source domain. For the target domain, the images are unlabeled, and thus [symbol] _{T}=X_{T}={xᵢ^{t}}ᵢ₌₁ⁿ^{ₜ}, wherein nₜ denotes the number of images in the target domain.

Referring to FIG. 3, the mutual learning network 300 for multi-source domain adaptation aims at exploiting both the domain specific adaptation information from each source domain and the combined adaptation information from the multi-source domains. Each source domain is paired with the target domain so as to form N source-target pairs. For example, the first source domain and the target domain are paired into the first source-target pair 310-1, the j-th source domain and the target domain are paired into the j-th source-target pair (not shown), and the N-th source domain and the target domain are paired into the N-th source-target pair 310-N. Moreover, all the source domains are combined into combined multi-source domains, and the combined multi-source domains and the target domain are paired into the (N+1)-th source-target pair 310-(N+1).

The mutual learning network 300 builds N+1 subnetworks 320-1 to 320-(N+1) for the N+1 source-target pairs 310-1 to 310-(N+1) for multi-source domain adaptation. The first N subnetworks 320-1 to 320-N perform domain adaptation from each source domain to the target domain, while the (N+1)-th subnetwork 320-(N+1) performs domain adaptation from the combined multi-source domains to the target domain. As the combined multi-source domains contain more information than each single source domain, it can reinforce the nonspontaneous common information shared across multi-source domains. As a result, the (N+1)-th subnetwork 320-(N+1) is used as a guidance subnetwork, while the first N subnetworks 320-1 to 320-N are used as branch subnetworks in the mutual learning network 300 of the present disclosure. The subnetworks may be various neural networks for image classification currently known or to be developed in the future, such as convolutional neural network.

All the subnetworks in the mutual learning network 300 may have the same structure, but use different training data. Each subnetwork in the mutual learning network 300 comprises a feature generator G, a domain discriminator D, and a category classifier F. As shown in FIG. 3, the branch subnetwork 320-1 comprises a feature generator 321-1, a domain discriminator 322-1, and a category classifier 323-1, the branch subnetwork 320-N comprises a feature generator 321-N, a domain discriminator 322-N, and a category classifier 323-N, and the guidance subnetwork 320-(N+1) comprises a feature generator 321-(N+1), a domain discriminator 322-(N+1), and a category classifier 323-(N+1). For each subnetwork, the corresponding source domain data and the target domain data are used as training inputs. As shown in FIG. 3, the first source data and the target data in the first source-target pair 310-1 are used as the training inputs for the branch subnetwork 320-1, the N-th source data and the target data in the N-th source-target pair 310-N are used as the training inputs for the branch subnetwork 320-N, and the combined multi-source data and the target data in the (N+1)-th source-target pair 310-(N+1) are used as the training inputs for the guidance subnetwork 320-(N+1). Thus, the mutual learning network 300 exploits each source domain for domain adaptation in both domain specific manner through the branch subnetworks and domain ensemble manner through the guidance subnetwork.

For each subnetwork, the input image data first go through the feature generator (such as feature generator 321-1) to generate high level features. Conditional adversarial feature alignment is then conducted to align feature distributions between each specific source domain (or the combined multi-source domains) and the target domain using a separate domain discriminator (such as discriminator 322-1) as an adversary with an adversarial loss L_{adv}. The classifier (such as classifiers 323-1) predicts the class labels of the input images based on the aligned features with classification losses L_{C} and L_{E}, while mutual learning is conducted by enforcing prediction distribution alignment between each branch subnetwork and the guidance subnetwork on the same target images with a prediction inconsistency loss L_{M}. The classification losses L_{C} and L_{E} and adversarial loss L_{adv} are considered on each subnetwork, while the prediction inconsistency loss L_{M} considered between each branch subnetwork and the guidance subnetwork.

In some embodiments, the subnetworks 320-1 to 320-(N+1) may have independent network parameters. Alternatively, some network parameters may be shared between the subnetworks 320-1 to 320-(N+1) so as to improve the training efficiency. Each feature generator may have first few layers and last few layers. FIG. 4 illustrates a schematic diagram for sharing weights among all the subnetworks according to an embodiment of the present disclosure, the feature generator 321-1 has first few layers 411 and last few layers 412, the feature generator 321-N has first few layers 421 and last few layers 422, and the feature generator 321-(N+1) has first few layers 431 and last few layers 432. As shown in FIG. 4, the network parameters (such as weights) of the layers 411, 421, 431 may be shared across all the subnetworks so as to enable common low-level feature extraction, while the remaining layers 412, 422, and 432 do not share the network parameters so as to capture source domain specific information. In this way, the mutual learning network 300 may be trained more easily.

Continuing to refer to FIG. 3, where the conditional adversarial domain adaptation is performed to align feature distributions between each source domain and the target domain so as to induce domain invariant features. Since all the N+1 subnetworks share the same network structure, the conditional adversarial feature alignment is conducted in the same manner for different subnetworks. The fundamental difference is that different subnetworks use different source domain data as input and the adversarial alignment results will be source domain dependent. The j-th subnetwork is used as an example to describe the conditional adversarial feature alignment of the mutual learning network 300, where j is between 1 and (N+1).

The feature generator G (such as feature generator 321-1) and the adversarial domain discriminator D (such as discriminator 322-1) are used to achieve multi-source conditional adversarial feature alignment, which exploits the adversarial learning of the generative adversarial network (GAN) into the domain adaptation setting. For the j-th subnetwork, the feature generator Gⱼ and the domain discriminator Dⱼ are adversarial, wherein Dⱼ tries to maximally distinguish the source domain data Gⱼ(X_{S}_{ⱼ}) from the target domain data Gⱼ(Xᵣ), while the feature generator Gⱼ tries to maximally deceive the domain discriminator Dⱼ.

Various adversarial losses for GAN may be used as adversarial loss L_{adv} in embodiments of the present disclosure. In some embodiments, to improve the discriminability of the induced features toward the final classification task, the label prediction results of the classifier Fⱼ may be taken into account to perform the conditional adversarial domain adaptation with the adversarial loss L_{adv} of the j-th subnetwork with the example equation (1):

$${L}_{{adv}_{j}} = \frac{1}{{n}_{s}^{j}} {\sum }_{i = 1}^{{n}_{\text{?}}^{j}} log [ {D}_{j} ( Φ ( {G}_{j} ( {x}_{i}^{j} ) , {p}_{i}^{j} ) ) ] + \frac{1}{{n}_{t}} {\sum }_{i = 1}^{{n}_{i}} log [ 1 - {D}_{j} ( Φ ( {G}_{j} ( {x}_{i}^{t} ) , {p}_{i}^{{t}_{j}} ) ) ] \\ \text{?} \text{indicates text missing or illegible when filed} \qquad ( 1 )$$

where pᵢ^{j} denotes the prediction probability vector generated by the classifier Fⱼ on image xᵢ^{j} and pᵢ^{t}^{ⱼ} denotes the prediction probability vector generated by the classifier Fⱼ on image xᵢ^{t}, as shown in the equations (2):

pᵢ^{j}=Fⱼ(Gⱼ(xᵢ^{j})), pᵢ^{t}^{ⱼ}=Fⱼ(Gⱼ(xᵢ^{t})) (2)

where pᵢ^{j} is a length K vector with each entry indicating the probability that xᵢ^{j} belongs to the corresponding classification, Φ(.,.) denotes the conditioning strategy function, which may be a simple concatenation of its two elements.

In some embodiments, a multilinear conditioning function may be used so as to capture the cross covariance between feature representations and classifier predictions to help preserve the discriminability of the features. For example, the overall adversarial loss of all the N+1 subnetworks may be an average of adversarial losses of all subnetworks, as shown in the equation (3):

$${L}_{adv} = \frac{1}{N + 1} {\sum }_{j = 1}^{N + 1} {L}_{{adv}_{j}} \qquad ( 3 )$$

The classifier Fⱼ is used to achieve semi-supervised adaptive prediction loss. To increase the cross-domain adaptation capacity of the classifiers, the discriminability of the mutual learning network 300 on both the source domains and the target domain are taken into account. As shown in FIG. 3, the extracted domain invariant features generated by the feature generator Gⱼ in the j-th subnetwork are input to the classifier Fⱼ. A supervised cross-entropy loss may be used as the classification loss L_{C} in embodiments of the present disclosure, and the cross-entropy loss is generally used as a loss function for classification task. In some embodiments, for the labeled image from the j-th source domain, the supervised cross-entropy loss L_{C} may be used to perform the training as shown in example equation (4).

$${L}_{C} = - \frac{1}{N + 1} {\sum }_{j = 1}^{N + 1} ( \frac{1}{{n}_{s}^{j}} {\sum }_{i = 1}^{{n}_{\text{?}}^{i}} {y}_{i}^{0} {}_{}^{⊤}{log p}{}_{i}^{j} ) \\ \text{?} \text{indicates text missing or illegible when filed} \qquad ( 4 )$$

An unsupervised entropy loss may be used as the classification loss L_{E} in embodiments of the present disclosure. In some embodiments, for the unlabeled image from the target domain, the unsupervised entropy loss L_{E} may be used to perform the training as shown in example equation (5).

$${L}_{E} = - \frac{1}{N + 1} {\sum }_{j = 1}^{N + 1} ( \frac{1}{{n}_{t}} {\sum }_{i = 1}^{{n}_{i}} {p}_{i}^{{t}_{j}} {}_{}^{⊤}{log p}{}_{i}^{{t}_{j}} ) \qquad ( 5 )$$

The assumption is that if the source and target domains are well aligned, the classifier trained on the labeled source images should be able to make confident predictions on the target images and hence have small predicted entropy values. Therefore, embodiments of the present disclosure expect this entropy loss can help bridge domain divergence and induce useful discriminative features.

According to embodiments of the present disclosure, the mutual learning network 300 can achieve guidance subnetwork centered mutual learning. With the adversarial feature alignment in each branch subnetwork, the target domain is aligned with each source domain separately. Due to the existence of domain shifts among various source domains, the domain invariant features extracted and the classifier trained in one subnetwork will be different from those in another subnetwork. Under effective domain adaptation, the divergence between each subnetwork's prediction result on the target images and the true labels should be small. By sharing the same target images, the prediction results of all the subnetworks in the target domain should be consistent. Thus, to improve the generalization performance of the mutual learning network 300 and increase the robustness of network training, embodiments of the present disclosure conduct mutual learning over all the subnetworks by minimizing their prediction inconsistency in the shared target images.

Since the guidance subnetwork 320-(N+1) uses the data from all the source domains, it contains more transferable information than each branch subnetwork. Accordingly, prediction consistency may be enforced by aligning each branch subnetwork with the guidance network in terms of predicted label distribution for each target image.

In some embodiments, Kullback Leibler (KL) Divergence may be used to align the predicted label probability vector for each target image from the j-th branch network with the predicted label probability vector for the same target image from the guidance network, where KL divergence is a measure of how one probability distribution is different from another reference probability distribution. In some embodiments, the KL divergence between the predicted label probability vector of the branch subnetwork and the predicted label probability vector of the guidance subnetwork may be determined via example equation (6).

[symbol]

_{KL}(pᵢ^{t}^{ⱼ}∥pᵢ^{t}^{_{N+1}})=pᵢ^{t}^{ⱼ}^{T}[log pᵢ^{t}^{ⱼ}−log pᵢ^{t}^{_{N+1}}] (6)

where pᵢ^{t}^{ⱼ} represents the predicted label probability vector for the i-th image in the target domain generated by the j-th branch subnetwork, and pᵢ^{t}^{_{N+1}} is the predicted label probability vector for the i-th image in the target domain generated by guidance subnetwork.

Alternatively, in other embodiments, a symmetric Jensen-Shannon Divergence loss may be used to improve the asymmetric KL divergence metric. In probability theory and statistics, the Jensen-Shannon divergence is a method of measuring the similarity between two probability distributions. Jensen-Shannon Divergence is based on the KL divergence, with some notable and useful differences, including that it is symmetric and it always has a finite value. It is also known as information radius or total divergence to the average. In some embodiments, the prediction inconsistency loss L_{M} may be represented through symmetric Jensen-Shannon Divergence loss, as shown in example equation (7).

$${L}_{M} = \frac{1}{2 {Nn}_{t}} {\sum }_{j = 1}^{N} {\sum }_{i = 1}^{ni} [ {𝒟}_{KL} ( {p}_{i}^{{t}_{j}} \vert \vert {p}_{i}^{{t}_{N + 1}} ) + {𝒟}_{KL} ( {p}_{i}^{{t}_{N + 1}} \vert \vert {p}_{i}^{{t}_{j}} ) ] \qquad ( 7 )$$

The prediction inconsistency loss L_{M} can enforce regularizations on the prediction inconsistency on the target images across multiple subnetworks and promote mutual learning. Next, an overall adversarial loss may be set based on the above losses L_{adv}, L_{C}, L_{E} and L_{M}. In some embodiments, the overall adversarial loss may be represented through the equation (8) by integrating the adversarial loss L_{adv}, the supervised cross-entropy loss L_{C}, the unsupervised entropy loss L_{E}, and the prediction inconsistency loss L_{M}.

$${min}_{G , F} {max}_{D} {L}_{C} + {α L}_{M} + {β L}_{E} + {λ L}_{adv} \qquad ( 8 )$$

where α,β and λ denote trade-off hyperparameters, G, F and D denote the sets of N+1 feature generators, classifiers and domain discriminators, respectively.

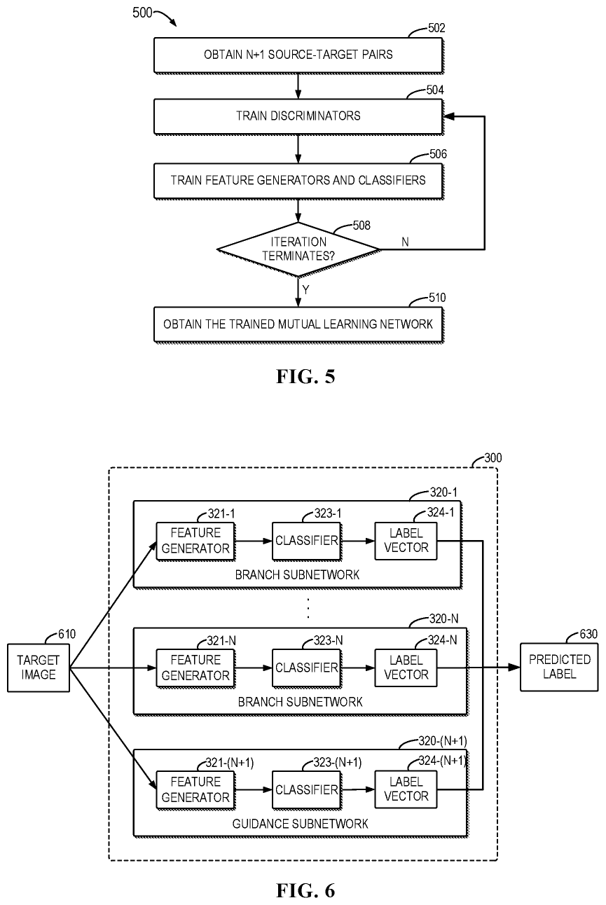

FIG. 5 illustrates a flow chart of a method 500 for iteratively training the mutual learning network 300 for multi-source domain adaptation according to embodiments of the present disclosure. For example, the standard stochastic gradient descent algorithms may be used for training, which may perform min-max adversarial updates.

At 502, N+1 source-target pairs are obtained, as discussed above, where the first N source-target pairs each comprises single source domain and the target domain, while the (N+1)-th pair comprises the combined source domains and the target domain. Then, an iterative training may be performed to the mutual leaning network 300.

At 504, the discriminators D are trained. For example, the parameters of all the feature generators G and classifiers F are fixed, the adversarial loss L_{adv} is caused to be maximum by optimizing and adjusting the parameters of the discriminators D.

At 506, the feature generators G and classifiers F are trained. For example, the parameters of all the discriminators D are fixed, and the adversarial loss L_{adv}, the supervised cross-entropy loss L_{C}, the unsupervised entropy loss L_{E}, and the prediction inconsistency loss L_{M} are caused to be a minimum by optimizing and adjusting the parameters of the feature generators G and classifiers F. For example, in each iteration, a plurality of images (e.g., 64 images) may be sampled from each source domain, the target domain and the combined multi-source domains.

At 508, it is determined whether the iteration terminates. For example, if each loss reaches the corresponding convergence value, the iteration may terminate. Alternatively, or in addition, if the number of repetitions of an iteration reaches a threshold, the iteration may terminate.

If a termination condition(s) for the iteration is not met, the method 500 may return to 504 and repeat training discriminators D at 504 and training the feature generators G and classifiers F at 506 until the termination condition(s) is met. If the iteration terminates, at 510, the trained mutual learning network is obtained. During the training, each loss may be assigned with a separate weight, and the weight of each loss may be adjusted to ensure the mutual leaning network 300 to be well optimized.

With the training, N+1 classifiers 320-1 to 320-(N+1) in the mutual learning network 300 have been trained. The trained classifiers 320-1 to 320-(N+1) may be used to determine the labels of the target images in the target domain in a guidance subnetwork centered ensemble manner. For the i-th image in the target domain, its overall prediction probability may be determined based on the prediction probability vectors generated by all the subnetworks. For example, the overall prediction probability result may be determined via equation (9). In equation (9), the prediction result from guidance subnetwork is given weight equal to the average prediction results from the other N branch subnetworks.

$${p}_{i}^{t} = \frac{1}{2} ( {p}_{i}^{{t}_{N + 1}} + \frac{1}{N} {\sum }_{j = 1}^{N} {p}_{i}^{{t}_{j}} ) \qquad ( 9 )$$

FIG. 6 illustrates a schematic diagram for using the trained mutual learning network 300 for multi-source domain adaptation according to embodiments of the present disclosure. A target image 610 in the target domain is input to subnetworks 310-1 to 310-(N+1) in the mutual learning network 300. In the branch subnetwork 320-1, the classifier 323-1 receives the features generated by the feature generator 321-1, and generates label vector 324-1 based on the received features. In the branch subnetwork 320-N, the classifier 323-N receives the features generated by the feature generator 321-N, and generates label vector 324-N based on the received features. In the branch subnetwork 320-(N+1), the classifier 323-(N+1) receives the features generated by the feature generator 321-(N+1), and generates label vector 324-(N+1) based on the received features. Then, the mutual leaning network 300 determines a final predicted label 630 based on the label vector 324-1, . . . , label vector 324-N and label vector 324-(N+1). Accordingly, the trained mutual learning network 300 according to embodiments of the present disclosure can generate the label for images in the target domain more accurately.

Embodiments of the present disclosure propose a novel mutual learning network architecture for multi-source domain adaptation, which enables guidance network centered information sharing in the multi-source domain setting. In addition, embodiments of the present disclosure propose dual alignment mechanisms at both the feature level and the prediction level, where the first alignment mechanism is conditional adversarial feature alignment across each source-target pair, and the second alignment mechanism is centered prediction alignment between each branch subnetwork and the guidance network. Thus, by use of the mutual learning network architecture and the dual alignment mechanisms, embodiments of the present disclosure can achieve a high accuracy for image label prediction.

In some embodiments, each source domain may comprise images captured through one type of camera. For example, images in the first source domain are captured by a normal camera and labeled, images in the second source domain are captured by a wide angle camera and labeled, and images in the third source domain are computer generated images and labeled. Images in the target domain may be captured by an ultra-wide angle camera and unlabeled. According to embodiments of the present disclosure, by using the labels in the first, second and third source domains, a mutual learning network for multi-source domain adaptation can be trained and be used to generate labels of images in the target domain. In addition, images captured under different weather conditions (such as sunny day, rainy day) may be also used as different source domains.

In some embodiments, the labels of the images in the source domain are driving scenarios for automatic driving, such as expressway, city roads, country roads, airports and so forth. Based on the driving scenario determined according to the image, the vehicle may be controlled to perform corresponding actions, such as changing the driving speed. Thus, the multi-source domain adaptation method with mutual learning network of the present disclosure can facilitate the automatic drive.

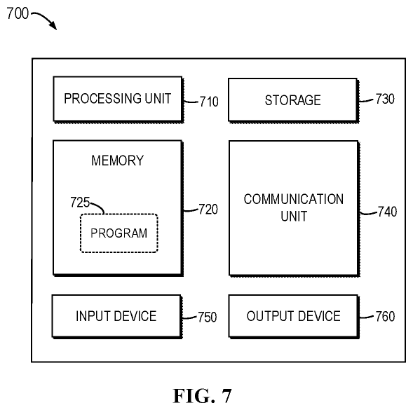

FIG. 7 illustrates a block diagram of an electronic device 700 in which one or more embodiments of the present disclosure may be implemented. It should be appreciated that the electronic device 700 as described in FIG. 7 is merely for illustration and does not limit the function and scope of embodiments of the present disclosure in any manner. For example, the electronic device 700 may be a computer or a server.

As shown in FIG. 7, the electronic device 700 is in the form of a general-purpose computing device. Components of the electronic device 700 may include, but are not limited to, one or more processor(s) or processing unit(s) 710, a memory 720, a storage device 730, one or more communication unit(s) 740, one or more input device(s) 750, and one or more output device(s) 760. The processing unit 710 may be a physical or virtual processor and perform various processes based on programs stored in the memory 720. In a multiprocessor system, a plurality of processing units may execute computer executable instructions in parallel to improve parallel processing capability of the electronic device 700.

The electronic device 700 typically includes various computer storage media. The computer storage media may be any media accessible by the electronic device 700, including but not limited to volatile and non-volatile media, or removable and non-removable media. The memory 720 can be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof.

As shown in FIG. 7, the memory 720 may include a program 725 for implementing the mutual learning network for multi-source domain adaptation according to embodiments of the present disclosure, which may have one or more sets of program modules configured to execute methods and functions of various embodiments described herein. The storage device 730 can be any removable or non-removable media and may include machine-readable media such as a flash drive, disk, and any other media, which can be used for storing information and/or data and accessed within the electronic device 700. For example, the storage device 730 may be a hard disc drive (HDD) or a solid state drive (SSD).

The electronic device 700 may further include additional removable/non-removable or volatile/non-volatile storage media. Although not shown in FIG. 7, a magnetic disk drive is provided for reading and writing from/to a removable and non-volatile disk (e.g., “a floppy disk”) and an optical disk drive may be provided for reading or writing from/to a removable non-volatile optical disk. In such cases, each drive is connected to the bus (not shown) via one or more data media interfaces.

The communication unit 740 communicates with another computing device via communication media. Additionally, functions of components in the electronic device 700 may be implemented in a single computing cluster or a plurality of computing machines that communicate with each other via communication connections. Therefore, the electronic device 700 can be operated in a networking environment using a logical connection to one or more other servers, networked personal computers (PCs), or another network node.

The input device 750 may include one or more input devices such as a mouse, keyboard, tracking ball and the like. The output device 760 may include one or more output devices such as a display, loudspeaker, printer, and the like. The electronic device 700 can further communicate, via the communication unit 740, with one or more external devices (not shown) such as a storage device or a display device, one or more devices that enable users to interact with the electronic device 700, or any devices that enable the electronic device 700 to communicate with one or more other computing devices (for example, a network card, modem, and the like). Such communication can be performed via input/output (I/O) interfaces (not shown).

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single implementation. Conversely, various features that are described in the context of a single implementation may also be implemented in multiple embodiments separately or in any suitable sub-combination.

Although the present disclosure has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer-implemented method, comprising:
generating, by a first classifier, a first representation of a target image in a target data, the first classifier being trained using a first source data and the target data;
generating, by a second classifier, a second representation of the target image, the second classifier being trained using a second source data and the target data, the first and second source data comprising labeled images and the target data comprising unlabeled images;
generating, by a third classifier, a third representation of the target image, the third classifier being trained using at least the first and second source data and the target data, and a mutual learning being conducted among the first, second and third classifiers during the training; and
determining a label of the target image based on the first, second and third representations.

2. The method according to claim 1, further comprising:
training a mutual learning network using the first and second source data and the target data, the mutual learning network comprising a first conditional adversarial subnetwork, a second conditional adversarial subnetwork, and a third conditional adversarial subnetwork, the first conditional adversarial subnetwork comprising a first feature generator, a first discriminator and the first classifier, the second conditional adversarial subnetwork comprising a second feature generator, a second discriminator and the second classifier, and the third conditional adversarial subnetwork comprising a third feature generator, a third discriminator and the third classifier.

3. The method according to claim 2, wherein training the mutual learning network comprises:
training the first conditional adversarial subnetwork by using a first pair of the first source data and the target data as an input;
training the second conditional adversarial subnetwork by using a second pair of the second source data and the target data as an input; and
training the third conditional adversarial subnetwork by using a third pair of a combination of at least the first and second source data and the target data as an input.

4. The method according to claim 2, wherein training the mutual learning network comprises:
performing a conditional adversarial feature alignment to align feature distributions between the first source data and the target data;
performing a conditional adversarial feature alignment to align feature distributions between the second source data and the target data; and
performing a conditional adversarial feature alignment to align feature distributions between a combination of at least the first and second source data and the target data.

5. The method according to claim 4, wherein training the mutual learning network further comprises:
performing a prediction alignment to align prediction probability distributions of target images between the first conditional adversarial subnetwork and the third conditional adversarial subnetwork; and
performing a prediction alignment to align prediction probability distributions of target images between the second conditional adversarial subnetwork and the third conditional adversarial subnetwork.

6. The method according to claim 5, wherein one or more layers in the first feature generator, one or more layers in the second feature generator, and one or more layers in the third feature generator share the same network parameters.

7. The method according to claim 2, wherein training the mutual learning network comprises:
iterating the following until a termination condition is met:
training the first, second and third discriminators by fixing the first, second and third feature generators and classifiers; and
training the first, second and third feature generators and classifiers by fixing the first, second and third discriminators.

8. The method according to claim 1, wherein the first source data is obtained from a first type of camera, the second source data is obtained from a second type of camera, and determining a label of the target image based on the first, second and third representations comprises:
determining a scenario of a vehicle according to the label of the target image; and
controlling the vehicle to perform an action according to the scenario.

9. An electronic device, comprising:
a processing unit;
a memory coupled to the processing unit and storing instructions thereon, the instructions, when executed by the processing unit, performing a method comprising:
generating, by a first classifier, a first representation of a target image in a target data, the first classifier being trained using a first source data and the target data;
generating, by a second classifier, a second representation of the target image, the second classifier being trained using a second source data and the target data, the first and second source data comprising labeled images and the target data comprising unlabeled images;
generating, by a third classifier, a third representation of the target image, the third classifier being trained using at least the first and second source data and the target data, and a mutual learning being conducted among the first, second and third classifiers during the training; and
determining a label of the target image based on the first, second and third representations.

10. The device according to claim 9, wherein the method further comprises:
training a mutual learning network using the first and second source data and the target data, the mutual learning network comprising a first conditional adversarial subnetwork, a second conditional adversarial subnetwork, and a third conditional adversarial subnetwork, the first conditional adversarial subnetwork comprising a first feature generator, a first discriminator and the first classifier, the second conditional adversarial subnetwork comprising a second feature generator, a second discriminator and the second classifier, and the third conditional adversarial subnetwork comprising a third feature generator, a third discriminator and the third classifier.

11. The device according to claim 10, wherein training the mutual learning network comprises:
training the first conditional adversarial subnetwork by using a first pair of the first source data and the target data as an input;
training the second conditional adversarial subnetwork by using a second pair of the second source data and the target data as an input; and
training the third conditional adversarial subnetwork by using a third pair of a combination of at least the first and second source data and the target data as an input.

12. The device according to claim 10, wherein training the mutual learning network comprises:
performing a conditional adversarial feature alignment to align feature distributions between the first source data and the target data;
performing a conditional adversarial feature alignment to align feature distributions between the second source data and the target data; and
performing a conditional adversarial feature alignment to align feature distributions between a combination of at least the first and second source data and the target data.

13. The device according to claim 12, wherein training the mutual learning network further comprises:
performing a prediction alignment to align prediction probability distributions of target images between the first conditional adversarial subnetwork and the third conditional adversarial subnetwork; and
performing a prediction alignment to align prediction probability distributions of target images between the second conditional adversarial subnetwork and the third conditional adversarial subnetwork.

14. The device according to claim 13, wherein one or more layers in the first feature generator, one or more layers in the second feature generator, and one or more layers in the third feature generator share the same network parameters.

15. The device according to claim 10, wherein training the mutual learning network comprises:
iterating the following until a termination condition is met:
training the first, second and third discriminators by fixing the first, second and third feature generators and classifiers; and
training the first, second and third feature generators and classifiers by fixing the first, second and third discriminators.

16. The device according to claim 9, wherein the first source data is obtained from a first type of camera, the second source data is obtained from a second type of camera, and determining a label of the target image based on the first, second and third representations comprises:
determining a scenario of a vehicle according to the label of the target image; and
controlling the vehicle to perform an action according to the scenario.

17. A non-transitory computer-readable medium having executable instructions stored whereon, the executable instructions, when executed on a device, causing the device to perform a method comprising:
generating, by a first classifier, a first representation of a target image in a target data, the first classifier being trained using a first source data and the target data;
generating, by a second classifier, a second representation of the target image, the second classifier being trained using a second source data and the target data, the first and second source data comprising labeled images and the target data comprising unlabeled images;
generating, by a third classifier, a third representation of the target image, the third classifier being trained using at least the first and second source data and the target data, and a mutual learning being conducted among the first, second and third classifiers during the training; and
determining a label of the target image based on the first, second and third representations.

18. The non-transitory computer-readable medium according to claim 17, wherein the method further comprises:
training a mutual learning network using the first and second source data and the target data, the mutual learning network comprising a first conditional adversarial subnetwork, a second conditional adversarial subnetwork, and a third conditional adversarial subnetwork, the first conditional adversarial subnetwork comprising a first feature generator, a first discriminator and the first classifier, the second conditional adversarial subnetwork comprising a second feature generator, a second discriminator and the second classifier, and the third conditional adversarial subnetwork comprising a third feature generator, a third discriminator and the third classifier.

19. The non-transitory computer-readable medium according to claim 18, wherein training the mutual learning network comprises:
performing a conditional adversarial feature alignment to align feature distributions between the first source data and the target data;
performing a conditional adversarial feature alignment to align feature distributions between the second source data and the target data; and
performing a conditional adversarial feature alignment to align feature distributions between a combination of at least the first and second source data and the target data.

20. The non-transitory computer-readable medium according to claim 19, wherein training the mutual learning network further comprises:
performing a prediction alignment to align prediction probability distributions of target images between the first conditional adversarial subnetwork and the third conditional adversarial subnetwork; and
performing a prediction alignment to align prediction probability distributions of target images between the second conditional adversarial subnetwork and the third conditional adversarial subnetwork.
